(19) United States
(12) Patent Application Publication
(10) Pub. No.: US 2006/0192890 A1
(43) Pub. Date: Aug. 31, 2006

(54) Electronic device

(75) Inventors: Tomonori Watanabe, Tokyo (JP); Tetsuya Okuchi, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/350,337

(22) Filed: Feb. 8, 2006

(30) Foreign Application Priority Data
Feb. 9, 2005 (JP) P2005-032571

(51) Int. Cl. H04N 5/225

(52) U.S. Cl. 348/373

(57) ABSTRACT

An electronic device has a flat chassis containing a recording medium mounting unit and a battery mounting unit. In the device, one of the recording medium mounting unit and the battery mounting unit is positioned approximately at the center of the chassis and the other is positioned to one side of the mounting unit positioned approximately at the center of the chassis. An opening of the mounting unit positioned approximately at the center of the chassis is provided on a first end face of the chassis and an opening of the other mounting unit is provided on a second end face of the chassis continuous with the first end face of the chassis.

### CROSS-REFERENCE TO RELATED APPLICATIONS

The present application claims priority from Japanese Patent Application No. JP 2005-032571, filed on Feb. 9, 2005, the disclosure of which is hereby incorporated by reference herein.

### BACKGROUND OF THE INVENTION

The present invention relates to an electronic device such as a digital camera and a handheld gaming device using a recording medium such as a memory card and a battery.

An electronic device such as a digital camera and a handheld gaming device uses a recording medium (hereafter referred to as a memory card) as mentioned above and a battery. The electronic device has a recording medium mounting unit (hereafter referred to as a memory card mounting unit) to house the memory card and a battery mounting unit to house the battery. The memory card mounting unit houses the memory card and the battery mounting unit houses the battery (e.g., JP-A No. 276418/1994).

The electronic device in the past is provided with the memory card mounting unit and the battery mounting unit in the chassis. A large part of space is used for the memory card mounting unit and the battery mounting unit, making it difficult to miniaturize and thin the chassis (as thin as a card).

### SUMMARY OF THE INVENTION

There is a need for miniaturizing and thinning the chassis (as thin as a card) by devising the arrangement of the recording medium mounting unit, the battery mounting unit, a printed wiring board, and the like, and for improving the usability of the electronic device.

The electronic device according to an embodiment of the present invention has a flat chassis (housing) that contains a recording medium mounting unit (accommodating section) and a battery mounting unit. One of the recording medium mounting unit and the battery mounting unit is positioned approximately at the center of the chassis. The other mounting unit is positioned to one side of the mounting unit disposed approximately at the center of the chassis. An opening of the mounting unit positioned approximately at the center of the chassis is provided on a first end face of the chassis. An opening of the other mounting unit is provided on a second end face of the chassis continuous with the first end face of the chassis. More specifically, the recording medium mounting unit is arranged approximately at the center of the chassis. The battery mounting unit is arranged to one side of the recording medium mounting unit. A main circuit board is arranged in the chassis so as to overlap with the recording medium mounting unit.

A battery contact terminal is provided at one side of the main circuit board and between the recording medium mounting unit and the battery mounting unit. The battery contact terminal contacts a terminal of a battery mounted in the battery mounting unit.

A divider plate is used to divide an inside of the chassis into first, second, and third parts mounting spaces. The first parts mounting space is positioned between the divider plate and the first principal plane of the chassis. The second parts mounting space is positioned between the divider plate and the second principal plane of the chassis. The third parts mounting space is free from the divider plate.

The first parts mounting space contains the recording medium mounting unit, the battery mounting unit, and the main circuit board. The first parts mounting space further contains a capacitor, an AF illuminator, and a flash unit that form a strobe unit.

The capacitor is arranged between the battery mounting unit and a fourth end face of the chassis opposite the first end face. The AF illuminator and the flash unit are arranged between the recording medium mounting unit and the fourth end face of the chassis. A liquid crystal panel is arranged in the second parts mounting space. A lens unit is arranged in the third parts mounting space.

The lens unit includes an imaging lens arranged to a side of the flash unit and the AF illuminator. An iris driving unit is provided on one side of the lens unit. At least part of the iris driving unit projects into the first parts mounting space.

The main circuit board and the recording medium mounting unit are provided with a cutout to accommodate at least part of the iris driving unit. The iris driving unit is displaced so as to project toward the first principal plane of the chassis from the lens unit. The bottom of the iris driving unit is provided with a panel support hole for receiving one end of the liquid crystal panel.

The first principal plane of the chassis is provided with a protrusion guide hole for receiving a portion of the iris driving unit protruding toward the first principal plane of the chassis.

One end of the divider plate is positioned toward the second end face of the chassis. The other end thereof is positioned toward the fourth end face of the chassis through a pair of arms.

A strap fitting is provided on the outside of the second end face of the chassis having the opening for the battery mounting unit. The second end face of the chassis and the strap fitting may be integrally formed by means of aluminum die casting.

One of the recording medium mounting unit and the battery mounting unit is positioned approximately at the center of the chassis. The other mounting unit is positioned to one side of the mounting unit disposed approximately at the center of the chassis. An opening of the mounting unit arranged approximately at the center of the chassis is provided on a first end face of the chassis. An opening of the other mounting unit is provided on a second end face of the chassis continuous with the first end face. In this manner, it is possible to prevent the same end face from having multiple openings. In addition, a recording medium (memory card) and a battery can be inserted into the corresponding mounting units from different directions that form an angle of approximately 90°.

Generally, a battery is heavier than a recording medium. The battery may fall out of the battery mounting unit due to its own weight when the battery mounting unit is arranged approximately at the center of the chassis and the mounting unit's opening is provided in the bottom end face as the first end face of the chassis. To solve this problem, the battery is inserted from an opening provided in a side end face of the chassis as the second end face of the chassis. This prevents the battery from falling out of the opening due to its own weight. Further, a memory card lighter than the battery is mounted in the recording medium mounting unit provided at the center of the chassis. This decreases possibilities where the recording medium may fall out of the opening due to its weight.

The main circuit board is provided so as to overlap with the mounting unit approximately at the center of the chassis. The main circuit board is accordingly arranged approximately at the center of the chassis. This facilitates connection between the main circuit board and its peripheral parts.

The battery contact terminal is provided at one side of the main circuit board and between the recording medium mounting unit and the battery mounting unit. When a battery is inserted into the battery mounting unit, a terminal at the end of the battery can contact the battery contact terminal on the one side of the main circuit board.

The divider plate is used to divide the inside of the chassis into first, second, and third parts mounting spaces. The first parts mounting space is positioned between the divider plate and the first principal plane of the chassis. The second parts mounting space is positioned between the divider plate and the second principal plane of the chassis. The third parts mounting space is free from the divider plate. In this manner, the respective parts can be orderly arranged in the first to third parts mounting spaces.

The first parts mounting space contains the recording medium mounting unit, the battery mounting unit, the main circuit board, and the strobe unit. Accordingly, the main circuit board can connect with the strobe unit and the like in the first parts mounting space. More specifically, the strobe unit's capacitor is arranged using a free space between the battery mounting unit and the fourth end face of the chassis opposite the first end face of the chassis. The AF illuminator and the flash unit forming the strobe unit are arranged using a free space between the battery mounting unit and the fourth end face of the chassis. In this manner, the various parts can be effectively arranged without leaving unused space in the narrow chassis. The liquid crystal panel is arranged in the second parts mounting space. The rear (bottom) of the liquid crystal panel is supported by the divider plate. This prevents the liquid crystal panel from being deformed even when its obverse is pressed.

As mentioned above, the divider plate forms a boundary between the first and second parts mounting spaces. To one side of the divider plate, the first parts mounting space contains the recording medium mounting unit, the battery mounting unit, the main circuit board, and the like. To the other side of the divider plate, the second parts mounting space contains the liquid crystal panel. The third parts mounting space contains the lens unit. The third parts mounting space is free from the divider plate and provides the largest space between the first and second principal planes of the chassis. Accordingly, the third parts mounting space can contain the lens unit that is the thickest of the other parts mounted in the chassis. The liquid crystal panel and the lens unit are arranged without overlapping with each other.

The iris driving unit protrudes from one side of the lens unit. At least part of the iris driving unit projects into the first parts mounting space. The lens unit requires the iris driving unit. The iris driving unit necessarily becomes wider than the lens unit. When the lens unit is designed in accordance with the width of the iris driving unit, the width of the lens unit becomes larger as a whole. To solve this problem, at least part of the iris driving unit protrudes from one side of the lens unit and projects into the first parts mounting space. This eliminates the need to design the lens unit in accordance with the width of the iris driving unit. The main circuit board and the recording medium mounting unit are provided with a cutout to accommodate at least part of the iris driving unit that protrudes from one side of the lens unit. The iris driving unit can be introduced into the cutout. This makes it possible to arrange the main circuit board, the recording medium mounting unit, and the lens unit as closely as possible to each other.

The iris driving unit is displaced so as to project toward the first principal plane of the chassis from the lens unit. The bottom of the iris driving unit is provided with a panel support hole for receiving one end of the liquid crystal panel. The one end of the liquid crystal panel is introduced into the panel support hole. This makes it possible to arrange the liquid crystal panel and the lens unit as closely as possible to each other. The first principal plane of the chassis is provided with a protrusion guide hole for receiving the portion of the iris driving unit protruding toward the first principal plane of the chassis. The portion protruding toward the first principal plane is introduced into the protrusion guide hole and protrudes to the outside of the first principal plane through the protrusion guide hole. This prevents the entire chassis from being thickened.

One end of the divider plate is positioned toward the second end face of the chassis. The other end of the divider plate is positioned toward the fourth end face of the chassis through a pair of arms. This prevents the divider plate from bending toward the first principal plane of the chassis or the first principal plane from changing the capacity of the first or second parts mounting space. The strap fitting for attaching a strap is provided on the outside of the second end face of the chassis provided with the opening for the battery mounting unit. The strap fitting can be used as a grip to easily hold the camera body. The strap fitting contacts the battery cover when opened. The battery cover opens or closes the opening of the battery mounting unit. In this manner, the strap fitting restricts the angle with which the battery cover is opened and protects the battery cover.

The second end face of the chassis and the strap fitting may be integrally formed by means of aluminum die casting. This eliminates the need for assembling the strap fitting to the second end face of the chassis. Further, the strap fitting's thickness or shape can be easily changed, for example, in such a manner that the strap fitting is thickened at its root and is tapered toward the end.

### BRIEF DESCRIPTION OF THE DRAWINGS

Embodiments of the present invention will be described in detail based on the following figures, wherein:

FIG. 1A is a perspective view showing a barrier moved to a first position (opened);

FIG. 1B is a perspective view showing a barrier moved to a second position (closed);

FIG. 2A is a perspective view showing a camera viewed from the rear;

FIG. 2B is a perspective view showing the camera viewed from the bottom;

FIG. 3 is an exploded perspective view of a chassis;

FIG. 4 is another exploded perspective view the chassis;

FIG. 5 is a sectional view of the assembled chassis;

FIG. 6 is an exploded perspective view of the chassis and parts;

FIG. 7 is a perspective view showing the relationship among a divider plate, a liquid crystal panel, and an optical unit;

FIG. 8 is a perspective view showing the divider plate assembled with various parts;

FIG. 9 is another perspective view showing the divider plate assembled with various parts;

FIG. 10 is a sectional view of the chassis whose divider plate is assembled with various parts;

FIG. 11 is a perspective view showing the barrier removed;

FIG. 12 is an exploded perspective view of the barrier;

FIG. 12 is a perspective view showing installation of rollers;

FIG. 14A is an explanatory diagram showing action of a toggle spring;

FIG. 14A is another explanatory diagram showing action of the toggle spring;

FIG. 15 is an explanatory diagram of the toggle spring;

FIG. 16 is a perspective view showing a battery cover closed;

FIG. 17 is a perspective view showing the battery cover opened;

FIG. 18 is a perspective view showing the battery cover and a shaft;

FIG. 19 is a front view of the battery cover attached with the shaft;

FIG. 20A is an explanatory diagram showing action of the spring attached to one end of the shaft;

FIG. 20B is another explanatory diagram showing action of the spring attached to one end of the shaft;

FIG. 20C is yet another explanatory diagram showing action of the spring attached to one end of the shaft;

FIG. 21 is a perspective view showing the battery cover opened so as to mount a battery;

FIG. 22 is a perspective view showing the battery cover closed to mount the battery;

FIG. 23 is an explanatory diagram showing a battery release lever prevented from being slid back;

FIG. 23 is an explanatory diagram showing the battery pushed out;

FIG. 23 is an explanatory diagram showing the battery to be pushed out by the battery release lever;

FIG. 26 is a side view of a strap fitting;

FIG. 27 is a perspective view showing the camera not attached with a multi-connector;

FIG. 28 is a perspective view showing the camera attached with the multi-connector;

FIG. 29 is a sectional view showing the multi-connector to be engaged with the strap fitting;

FIG. 30 is a sectional view showing the multi-connector to be disengaged;

FIG. 31 is a sectional view showing a cover rotating mechanism with a memory card cover closed;

FIG. 32 is a sectional view showing the cover rotating mechanism with the memory card cover half-opened;

FIG. 33 is a sectional view showing the cover rotating mechanism with the memory card cover opened;

FIG. 34 is a sectional view showing a click mechanism with the memory card cover closed;

FIG. 35 is a sectional view showing the click mechanism with the memory card cover half-opened;

FIG. 36 is a sectional view showing the click mechanism with the memory card cover opened; and

FIG. 37 is a perspective view showing the memory card cover opened.

### DETAILED DESCRIPTION

The following describes the electronic device according to the present invention in the order of: (1) Overall construction of the electronic device; (2) Construction of the camera body; (3) Construction of the barrier; (4) Construction of the roller; (5) Construction of the barrier slide guide; (6) Construction of the toggle spring; (7) Construction of the memory card mounting unit's cover; (8) Construction of the battery mounting unit's cover; (9) Construction of the battery release lever; (10) Construction of the strap fitting; and (11) Other embodiments.

(1) Overall Construction of the Electronic Device

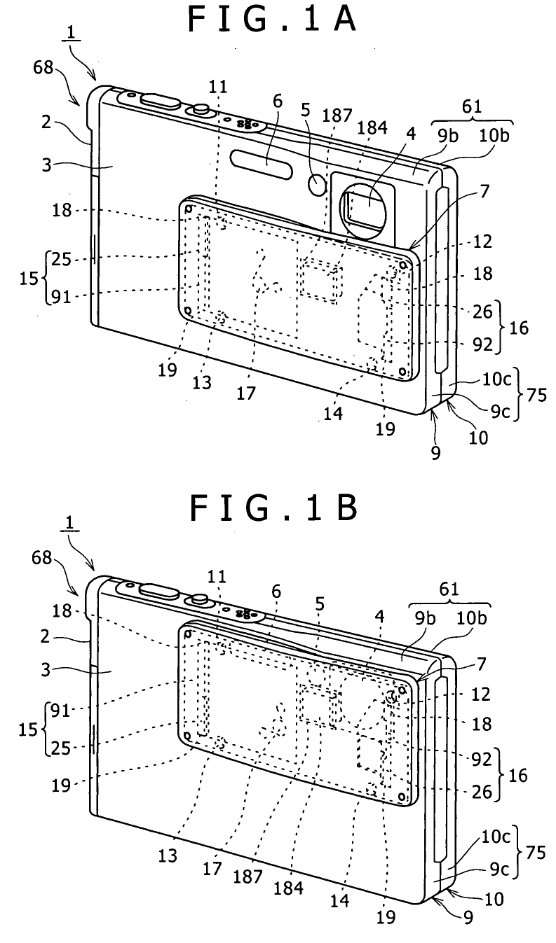

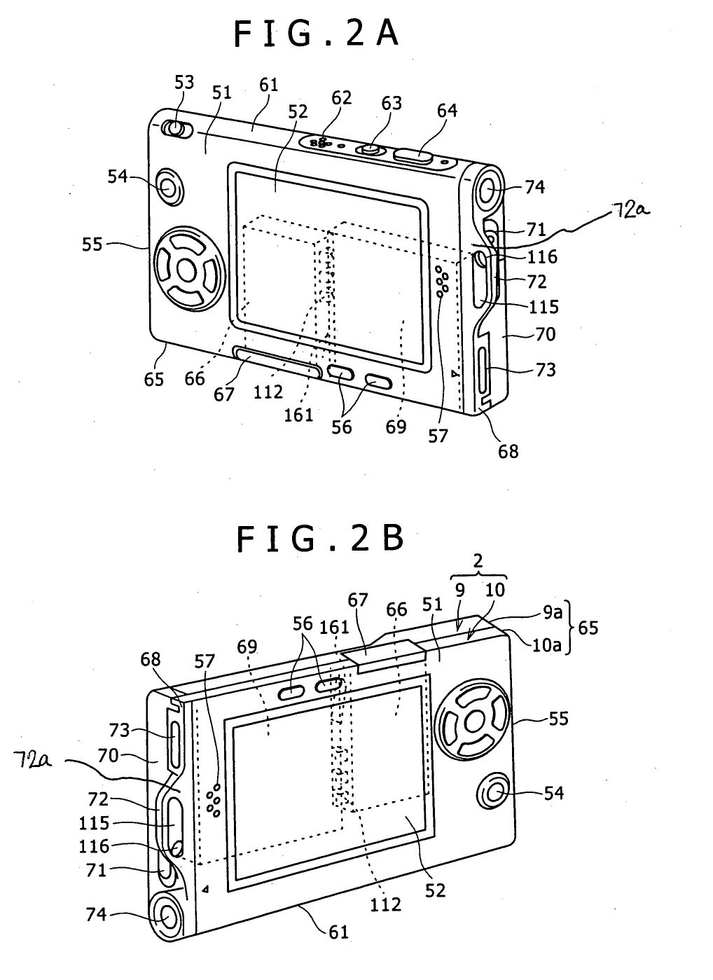

FIGS. 1A and 1B are perspective views showing a digital camera as the electronic device according to the present invention viewed from a first principal plane (front). FIG. 2 is a perspective view showing the digital camera according to the present invention viewed from a second principal plane (rear).

The digital camera 1 has a flat, rectangular parallelepipedic camera body 2. On its first principal plane 3, there are provided an imaging lens 4, an AF illuminator 5 for emitting auto-focus assist light, and a flash unit 6. FIG. 1A shows a first position that exposes the imaging lens 4, the AF illuminator 5, and the flash unit 6. FIG. 1B shows a second position that hides the imaging lens 4, the AF illuminator 5, and the flash unit 6. A barrier (lens cover) 7 is provided to be able to move between the first and second positions. An iris driving mechanism 184 is housed in the chassis 2 and partially protrudes from the first principal plane 3 of the chassis 2.

The iris driving mechanism 184 partially protrudes and is hidden by the barrier 7 at the first position as shown in FIG. 1A and at the second position as shown in FIG. 1B.

The barrier is approximately rectangularly formed. Its four corners are provided with first through fourth rollers 11 through 14 that touch the first principal plane 3 of the camera body 2. Along the moving direction, both sides of the barrier 7 are provided with a pair of first and second barrier slide guides 15 and 16. The barrier 7 uses the first through fourth rollers 11 through 14 and the first and second barrier slide guides 15 and 16 to move between the first and second positions on the first principal plane 3 of the camera body 2.

As will be described in detail in the section about the construction of the camera body, the first barrier slide guide 15 is composed of a first barrier engager 25 and a first barrier engaging unit 91. The first barrier engager 25 is provided on the camera body 2. The rail-shaped first barrier engaging unit 91 is provided on the barrier and slidably catches the first barrier engager 25. Similarly to the first barrier slide guide 15, the second barrier slide guide 16 is composed of a second barrier engager 26 and a second barrier engaging unit 92. The second barrier engager 26 is provided on the camera body 2. The rail-shaped second barrier engaging unit 92 is provided on the barrier and slidably catches the second barrier engager 26.

As shown in FIG. 1A, when the barrier 7 is moved to the first position, a barrier pressing spring (hereafter referred to as a toggle spring) 17 applies spring force. This force presses a first stopper 18 against the first and second barrier engagers 25 and 26. The first stopper 18 is provided at one end of each of the rail-shaped first and second barrier engaging units 91 and 92. This state exposes the imaging lens 4, the AF illuminator 5, and the flash unit 6. As shown in FIG. 1B, when the barrier 7 is moved to the second position, spring force of the toggle spring 17 presses a second stopper 19 against the first and second barrier engagers 25 and 26. The second stopper 19 is provided at the other end of each of the rail-shaped first and second barrier engaging units 91 and 92. This state hides the imaging lens 4, the AF illuminator 5, the flash unit 6, and part of the iris driving mechanism 8.

As shown in FIGS. 2A and 2B, the camera body contains a memory card mounting unit 66 that houses a recording medium such as a memory card. The memory card mounting unit 66 opens on a first end face (bottom end face) 65 connecting the first principal plane 3 and the second principal plane 51. The opening is used to mount or dismount a memory card from the memory card mounting unit 66. The memory card mounting unit 66 has a cover (hereafter referred to as a memory card cover) 67 that opens or closes the opening of the memory card mounting unit 66. The camera body contains a battery mounting unit 69 orthogonally to the memory card mounting unit 66. The battery mounting unit 69 opens on a second end face (right end face) 68 connecting the first principal plane 3 and the second principal plane 51. The opening is used to mount or dismount a battery from the battery mounting unit 69. A battery cover 70 is used to open or close the opening of the battery mounting unit 69. One side of the battery cover 70 is provided with a battery release lever 71, a strap fitting 72, a multi-connector connection terminal 73, and a power button 74. The strap fitting 72 overlaps with the battery cover 70 when opened. The battery release lever 71 allows a battery to be inserted into or removed from the battery mounting unit 69. The battery release lever 71 is arranged at one side of the battery cover so as not to overlap with the battery cover 70. An inside end face of the battery mounting unit 69 is provided with a battery contact terminal 112 and a battery ejection spring 161.

When a battery is inserted into the battery mounting unit 69, the battery's end face presses the battery ejection spring 161. The battery ejection spring 161 accumulates force. When the battery is placed in the battery mounting unit 69, the terminal on the battery's end face contacts with the battery contact terminal 112 provided inside the battery mounting unit 69. The end of the battery release lever 71 is used to press the rear of the battery to prevent the battery from being inadvertently removed from the battery mounting unit 69.

The battery can be removed from the battery mounting unit 69 using the battery release lever 71 to release the stop on the rear of the battery. The battery is pushed out of the battery mounting unit 69 for a specified amount due to the spring force of the battery ejection spring 161.

(2) Construction of the Camera Body

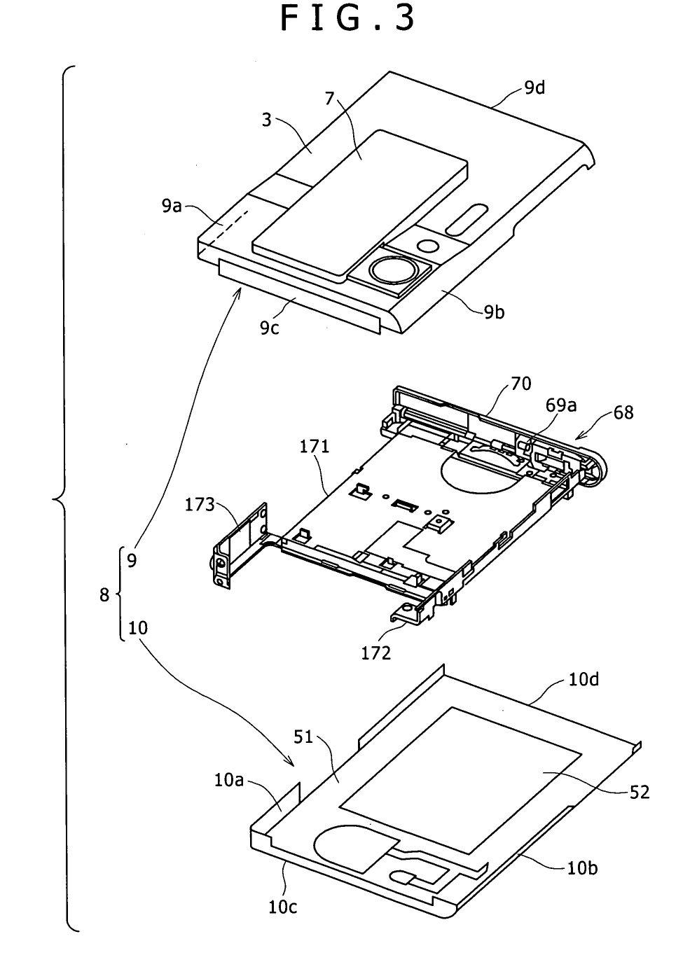

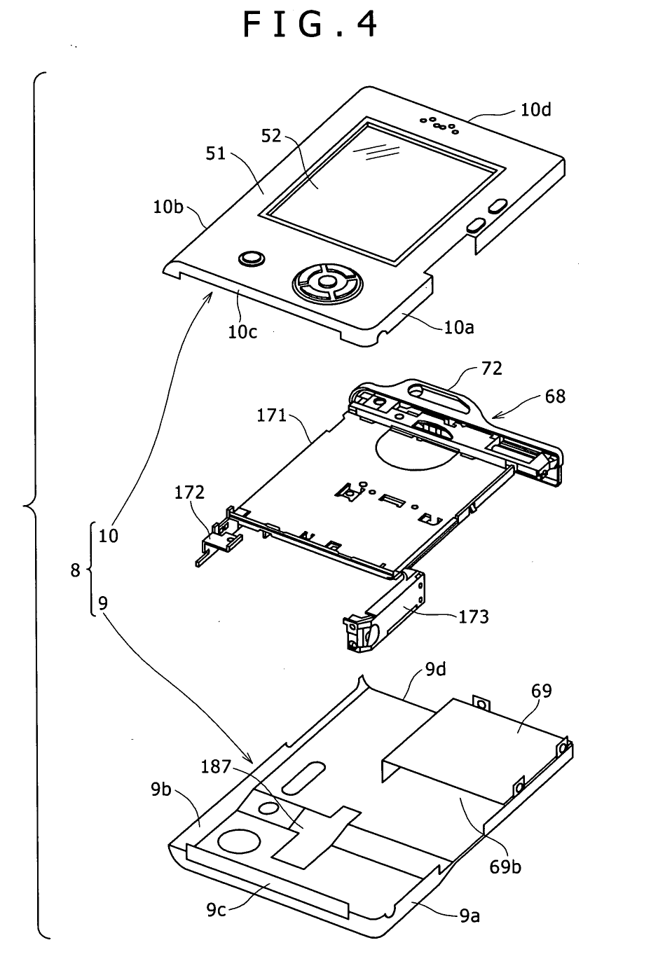

The camera body is constructed by assembling various parts on the chassis 8. As shown in FIGS. 3 and 4, the chassis 8 is formed by connecting a top cover plate 9 having the first principal plane 3 with a bottom cover plate 10 having the second principal plane 51. The first end face (bottom end face during normal use of the camera) 65 of the chassis 8 is formed by aligning a first edge 9a of the top cover plate 9 to a first edge 10a of the bottom cover plate 10 (see FIG. 2B).

The third end face (top end face) of the chassis 8 is formed by aligning a second edge 9b of the top cover plate 9 to a second edge 10b of the bottom cover plate 10 (see FIG. 1A). The fourth end face (to the left of a user during normal use of the camera) 75 of the chassis 8 is formed by aligning a second edge 9c of the top cover plate 9 to a second edge 10c of the bottom cover plate 10 (see FIG. 1A).

The fourth end face 75 is orthogonal to the top and bottom cover plates 9 and 10 whose ends 9d and 10d are opened to mount the second end face (to the right of a user during normal use of the camera) 68 of the chassis 8.

The chassis' second end face 68 is formed by aluminum die casting or plastic injection molding to form an opening 69a (see FIG. 3) of the battery mounting unit 69. The opening 69a is opened or closed by the battery cover 70 to be described later. As shown in FIG. 4, the strap fitting 72 is integrally formed outside the second end face 68. The inside of the second end face 68 contains a divider plate 171 to divide the chassis 8.

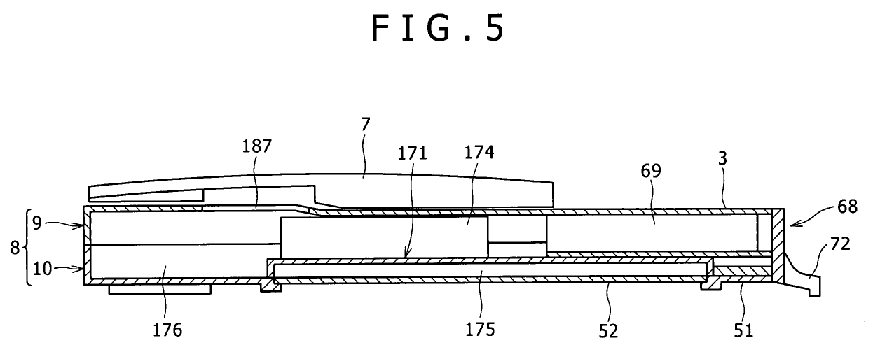

One side of the divider plate 171 is positioned to the inside of the second end face 68. The other side of the divider plate 171 is provided with first and second arms 172 and 173. The second end face 68 and the first and second arms 172 and 173 position the divider plate 171 between and approximately parallel to the first principal plane 3 and the second principal plane 51. As shown in FIG. 5, the divider plate 171 divides the chassis 8 into a first parts mounting space 174, a second parts mounting space 175, and a third parts mounting space 176. The first parts mounting space 174 is positioned between the divider plate 171 and the first principal plane 3 of the chassis 8. The second parts mounting space 175 is positioned between the divider plate 171 and the second principal plane 51 of the chassis 8. The third parts mounting space 176 is free from the divider plate 171. Reference numeral 52 denotes a transparent liquid crystal display window provided on the second principal plane 51.

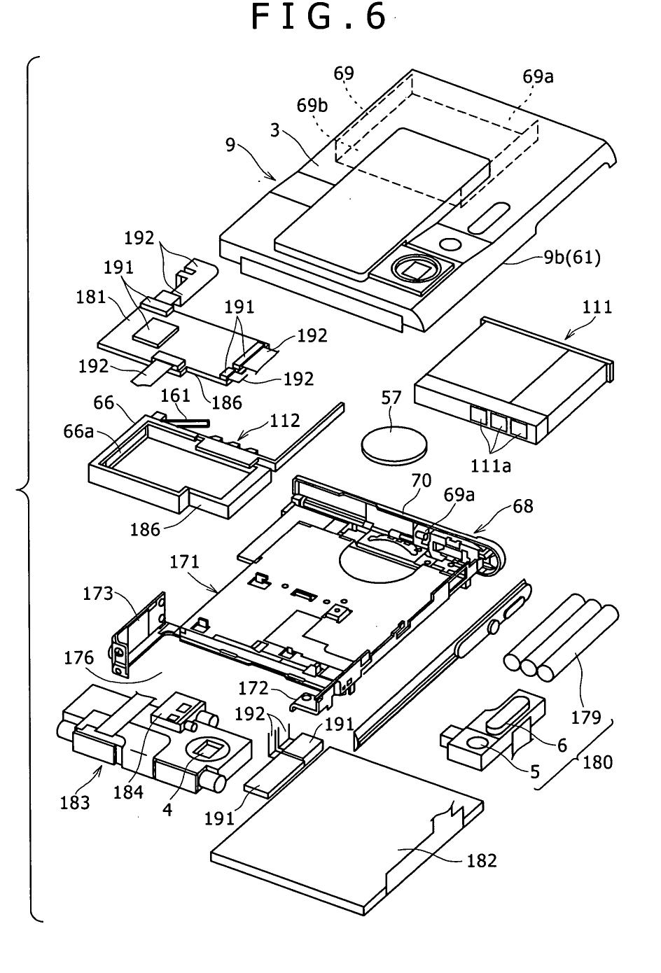

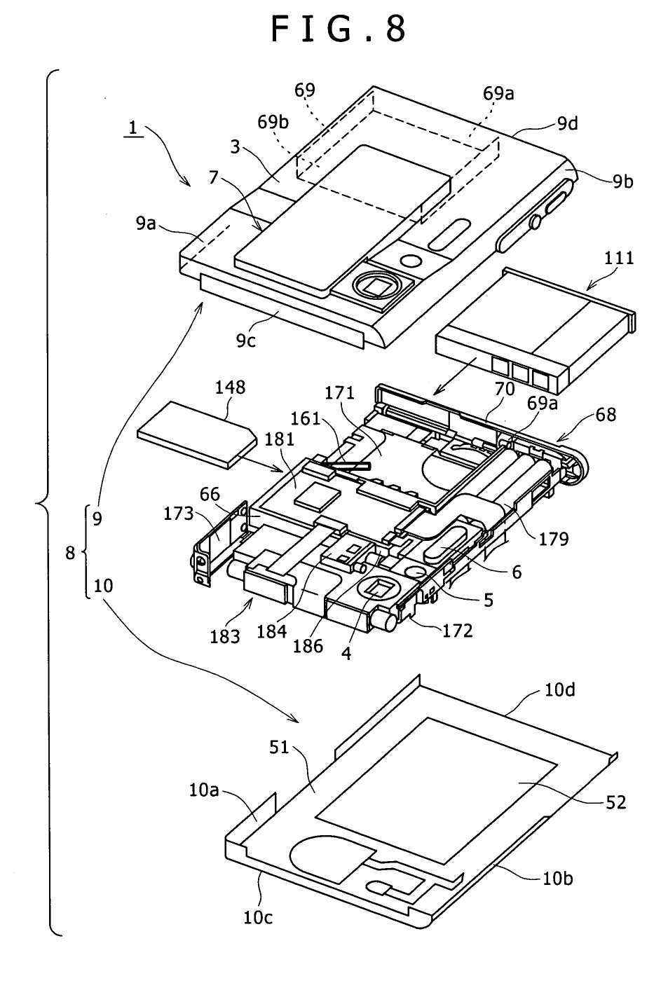

As shown in FIGS. 6 and 8, the first parts mounting space 174 contains a strobe unit 180, the memory card mounting unit 66, a main circuit board 181, the battery contact terminal 112, a speaker 57, and the battery mounting unit 69. The strobe unit 180 is composed of the AF illuminator 5, a strobe flash unit 6, and a capacitor 179.

The battery mounting unit 69 is provided inside the first principal plane 3 of the top cover plate 9. The battery mounting unit 69 is shaped in a flat, approximately rectangular cylinder. A battery can be inserted through the opening 69a in one end adjacent to the second end face 68 of the chassis 8. When the top cover plate 9 is assembled onto the divider plate 171, the battery mounting unit 69 is positioned above the divider plate 171.

The main circuit board 181 is attached so as to be placed on the memory card mounting unit 66. The memory card mounting unit 66 has an opening 66a positioned approximately at the center of a first end face 65 of the chassis 8. One side of the memory card mounting unit 66 is provided with the battery contact terminal 112. The battery contact terminal 112 faces toward an opening 69b at the end of the battery mounting unit 69. When the battery 111 is mounted in the battery mounting unit 69 through the opening 69a of the battery mounting unit 69, a power supply terminal 111a of the battery 111 contacts with the battery contact terminal 112 on one side of the memory card mounting unit 66.

The AF illuminator 5 and the strobe flash unit 6 are placed between the memory card mounting unit 66 and the third end face 61 of the chassis 8. The capacitor 179 is placed between the battery mounting unit 69 and the third end face 61 of the chassis 8.

The second parts mounting space 175 contains a liquid crystal panel 182. The rear of the liquid crystal panel 182 is supported on the divider plate 171. The display surface of the liquid crystal panel 182 is revealed to the outside through the transparent liquid crystal display window 52 provided on the second principal plane 51 of the bottom cover plate 10 of the chassis 8.

A lens unit 183 is placed in the third parts mounting space 176. The lens unit 183 provides an optical system in the vertical direction. The lens unit 183 uses a long and thin lens equipped with an optical zoom using a prism to bend an optical axis. The imaging lens 4 is provided at one end of the lens unit 183. The imaging lens 4 may be positioned to the chassis' third end face 61, i.e., to the side of the AP illuminator 5. In this state, the lens unit 183 is contained in the third parts mounting space 176.

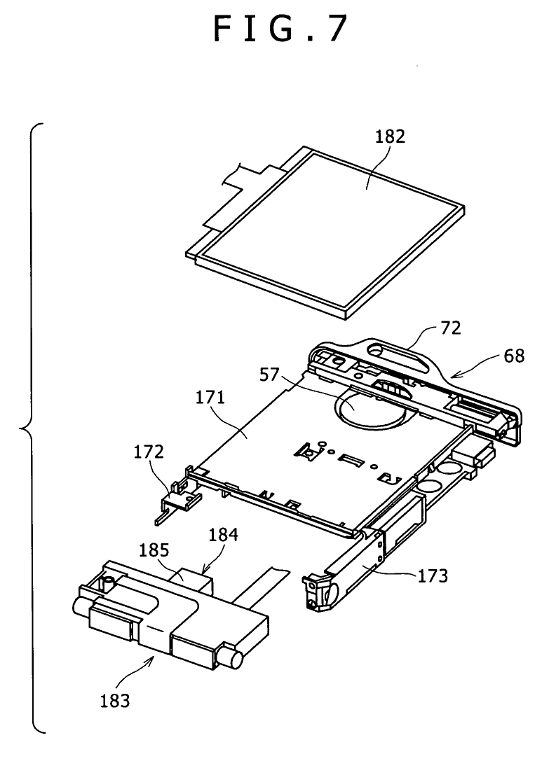

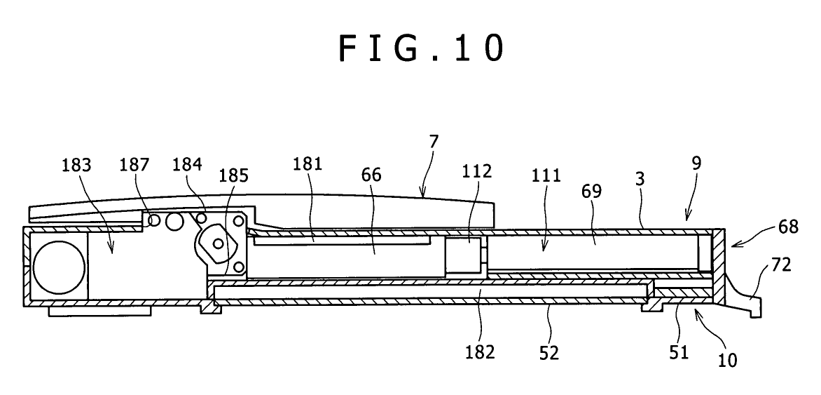

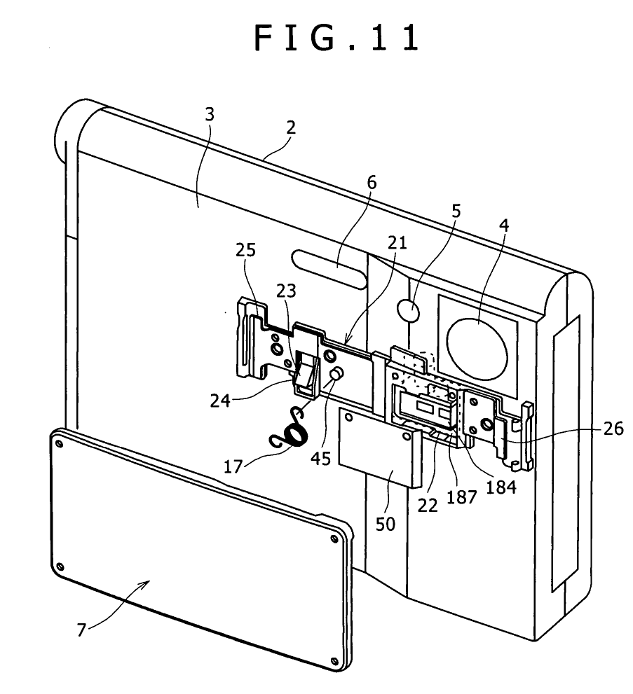

One side of the lens unit 183 is provided with an iris driving unit 184. At least part of the iris driving unit 184 enters the first parts mounting space 174. At least part of the iris driving unit 184 is displaced (protruded) toward the first principal plane 3 of the chassis 8. As shown in FIG. 7, at least part of the bottom of the iris driving unit 184 is provided with a recess 185 that can accept one side of the liquid crystal panel 182. As shown in FIG. 10, the recess 185 allows the liquid crystal panel 182 to be positioned nearer to the lens unit 183.

As shown in FIG. 6, the main circuit board 181 is provided with a cutout 186 that accepts part of the iris driving unit 184.

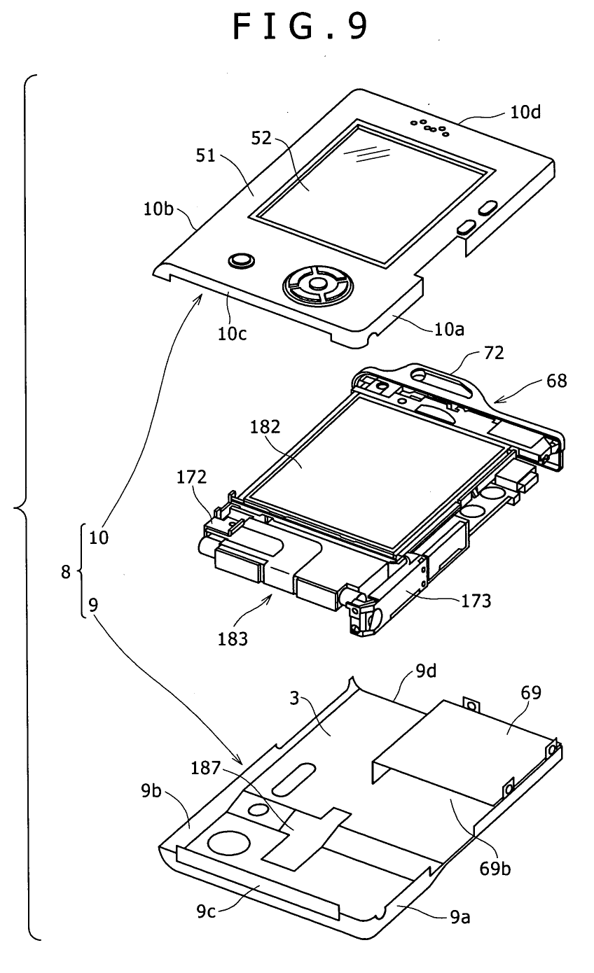

The iris driving unit 184 is displaced toward the first principal plane 3 of the chassis 8. As shown in FIG. 9, at least part of the iris driving unit 184 is fit into a protrusion guide hole 187 provided on the first principal plane 3 of the chassis 8. The iris driving unit 184 protrudes from the first principal plane 3 of the chassis 8 through the protrusion guide hole 187. As shown in FIGS. 1A and 1B, part of the iris driving unit 184 protruding from the photodetector 187 is hidden by the barrier 7 slidably attached to the outside of the first principal plane 3 of the chassis 8. As shown in FIG. 6, the main circuit board 181 is connected to the above-mentioned parts through multiple connectors 191 and harnesses 192.

FIG. 11 shows the barrier 7 removed. The imaging lens 4 is provided close to one corner at the top end of the first principal plane 3 of the flat and rectangular chassis 2. The AF illuminator 5 and the flash unit 6 are provided on one side of the imaging lens 4.

A base plate 21 is attached under the imaging lens 4, the AF illuminator 5, and the flash unit 6. The base plate 21 has a first opening 22 that contains part of the iris driving unit 184. The base plate 21 has a second opening 23 that is provided with a switch operation unit 24. The switch operation unit 24 is used to manipulate a barrier position detection switch (not shown) provided in the chassis 2. The barrier position detection switch is used to detect whether the barrier 7 is situated at the first position or the second position. Both sides of the base plate 21 are provided with a pair of first and second barrier engagers 25 and 26 that construct the first and second barrier slide guides 15 and 16.

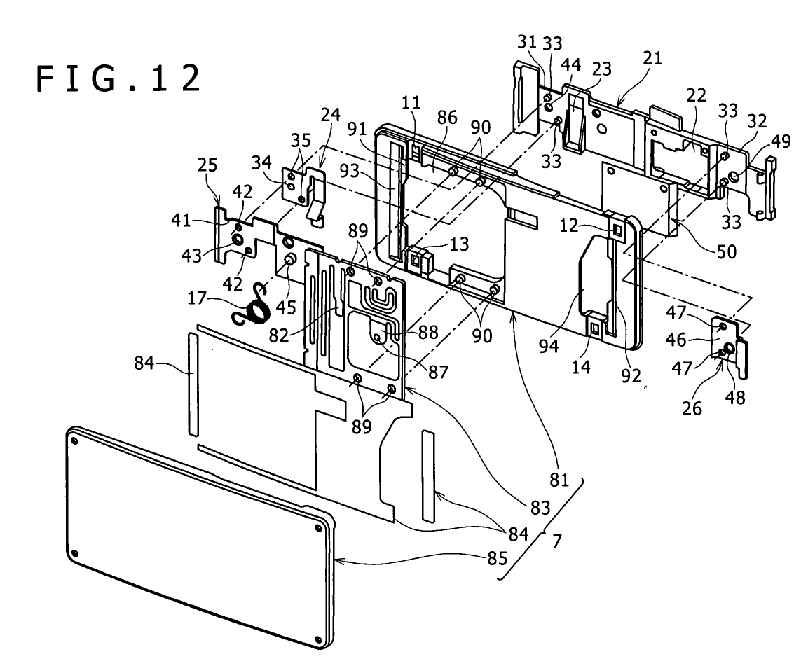

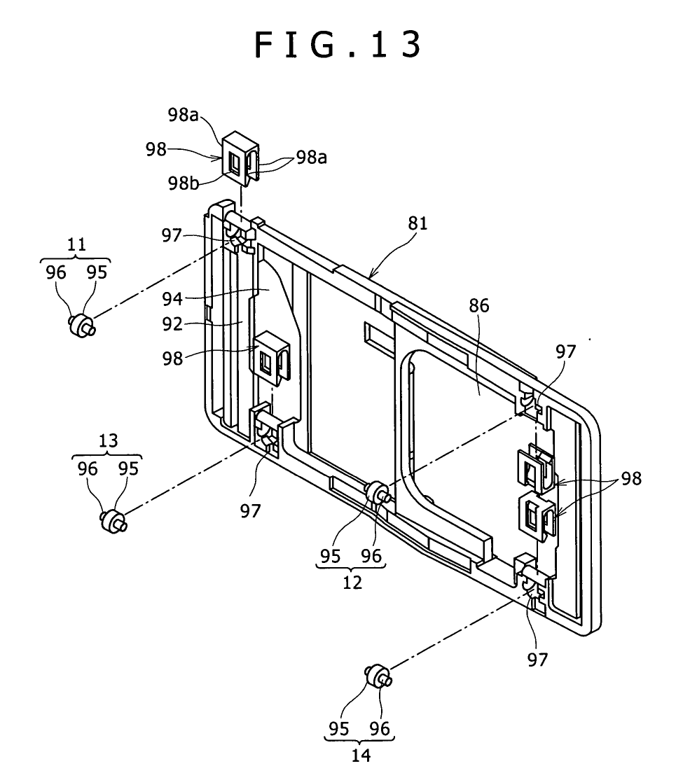

As shown in the exploded perspective view of FIG. 12, both sides of the first and second openings 22 and 23 in the base plate 21 are provided with first and second barrier engager attaching portions 31 and 32 for attaching the first and second barrier engagers 25 and 26. The first and second barrier engager attaching portions 31 and 32 have multiple bosses 33.

The switch operation unit 24 is formed by bending a leaf spring like a dogleg. One side of the switch operation unit 24 is provided with an attaching base 34 to attach the switch operation unit 24 to the base plate 23. The attaching base 34 is provided with multiple boss inserting holes 35 to insert bosses 33 provided on the first barrier engager 31.

The switch operation unit 24 is attached to the first barrier engager attaching portion 31 when the switch operation unit 24 is inserted into the second opening 23 and the multiple bosses 33 are inserted into the multiple boss inserting holes 35 on the attaching base 34.

The first barrier engager 25 is formed by bending a metal plate. One side of the first barrier engager 25 is provided with an attaching base 41 to attach the first barrier engager 25 to the base plate 21. The attaching base 41 is provided with multiple boss inserting holes 42 to fit the bosses 33 provided on the first barrier engager attaching portion 31.

As mentioned above, the bosses 33 on the first barrier engager attaching portion 31 are inserted into the boss inserting holes 35 in the attaching base 34 of the first barrier engager attaching portion 31. The bosses 33 are inserted into the boss inserting holes 42 in the attaching base 41. The tip of the boss 33 is caulked to enlarge the diameter. In this manner, the first barrier engager 25 is attached to the first barrier engager attaching portion 31 while the attaching base 34 of the switch operation unit 26 is sandwiched between the first barrier engager 25 and the first principal plane 3 of the chassis 2. Multiple positioning bosses 43 are provided on the attaching base 41 of the first barrier engager 25.

The positioning boss 43 is used when the first barrier engager 25 is attached to the first barrier engager attaching portion 31. At this time, the positioning boss 43 fits into the boss inserting hole 44 in the base plate 23 to position the first barrier engager 25. The attaching base 41 of the first barrier engager 25 is provided with a first spring locking portion 45 to lock one end of the toggle spring 17.

The second barrier engager 26 is formed by bending a metal plate similarly to the first barrier engager 25. One side of the second barrier engager 26 is provided with an attaching base 46 to attach the second barrier engager 26 to the base plate 23. The attaching base 46 is provided with multiple boss inserting holes 47 to fit the bosses 33 provided on the second barrier engager attaching portion 32.

The bosses 33 on the second barrier engager attaching portion 32 are inserted into the boss inserting holes 52 in the attaching base 46. The tip of the boss 33 is caulked to enlarge the diameter. In this manner, the second barrier engager 26 is attached to the second barrier engager attaching portion 32. A positioning boss is provided for the attaching base 46 of the second barrier engager 26. The positioning boss 48 is used when the second barrier engager 26 is attached to the second barrier engager attaching portion 32. At this time, the positioning boss 48 fits into the boss inserting hole 49 in the second barrier engager attaching portion 32 to position the second barrier engager 26. The first opening 22 in the base plate 21 is covered with an iris cover sheet 50 to prevent dust and the like from entering the chassis 2 through the first opening 22. As shown in FIG. 2A, the second principal plane 51 is opposite to the first principal plane 3 of the chassis 2 and is provided with a display portion 52 such as a liquid crystal display, a mode selection switch 53, a menu button 54, a control button 55, a screen display on/off button 56, and a speaker 57. The first end face (top end face) 61 connects the first principal plane 3 with the second principal plane 51 and is provided with a microphone 62, a zoom button 63, and a shutter 64.

(3) Construction of the Barrier

As shown in FIG. 12, the barrier 7 is composed of a frame-shaped inside portion 81, a metal plate 83, and an outside portion 85. The metal plate 83 is attached to the frame-shaped inside portion 81. The metal plate 83 is provided with a switch operation unit pressing portion 82 for pressing the switch operation unit 26. A double-sided adhesive tape 84 or the like is used to attach the outside portion 85 to the outside of the inside portion 81 mounted with the metal plate 83.

The inside portion 81 has an approximately rectangular cutout window 86. The metal plate 83 is attached so as to fit to the cutout window 86. There are formed the switch operation unit pressing portion 82 and a tongue 88 that are cut out and are raised from the metal plate 82. The tongue 88 has a second spring locking portion 87 that locks one end of the toggle spring 17. The other end of the toggle spring 17 is fastened to the first spring locking portion 45 provided on the attaching base 41 of the first barrier engager 25.

The periphery of the metal plate 83 has multiple boss inserting holes 89. These boss inserting holes 89 engage with bosses 90 around the cutout window 86 of the inside portion 81. The tips of these bosses 90 are caulked to enlarge the diameters. In this manner, the metal plate 83 is attached to the inside portion 81.

Four corners of the inside portion 81 are provided with first through fourth rollers 11 through 14 that contact with the first principal plane 3 of the chassis 2. In terms of the moving direction, both sides of the inside portion 81 are provided with first and second rail-shaped barrier engaging units 91 and 92. The barrier engaging units 91 and 92 engage with the first and second barrier engagers 25 and 26 attached to the base plate 21.

The first barrier engaging unit 91 is formed along one side of a first long hole 93 formed at one side of the inside portion 81. The second barrier engaging unit 92 is formed along another side of a second long hole 94 formed at another side of the inside portion 81. The first and second barrier engagers 27 and 28 and the first and second rail-shaped barrier engaging units 91 and 92 construct the first and second barrier slide guides 15 and 16.

(4) Construction of the Roller

As shown in FIG. 13, the first through fourth rollers 11 through 14 each have a disk-shaped roller body 95 and a rotating central shaft 96 protruding from both sides of the roller body 95. The first through fourth rollers 11 through 14 are placed in first through fourth roller receptacles 97 provided at four corners of the inside portion 81. The first through fourth rollers 11 through 14 are rotatable around the rotating central shafts 96.

An approximately horseshoe-shaped clip 98 is attached to the side of each of the first to fourth roller receptacles 97 that rotatably mount the first to fourth rollers 11 to 14. The approximately horseshoe-shaped clips 98 prevent the first to fourth rollers 11 to 14 from slipping out of the first to fourth roller receptacles 97. A cutout window 98b is provided in a pair of opposite sides 98a of the approximately horseshoe-shaped clip 98. The cutout window 98b exposes part of the disk-shaped roller body 95.

When the inside portion 81 overlaps with the first principal plane 3 of the chassis 2, the first to fourth rollers 11 to 14 contact with the first principal plane 3 of the chassis 2.

(5) Construction of the Barrier Slide Guide

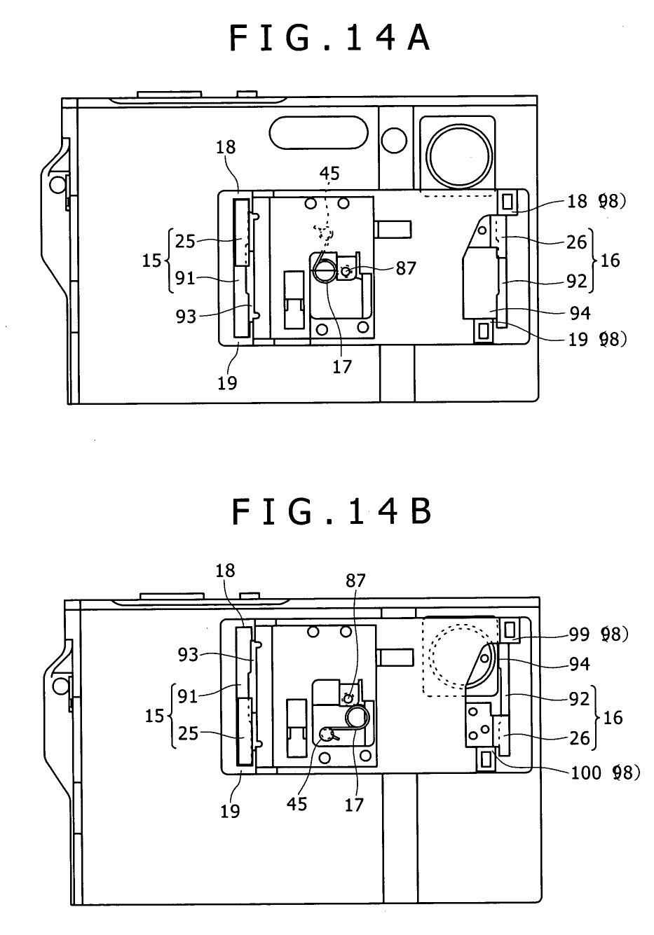

The barrier slide guide guides the movement of the barrier 7. As shown in FIG. 14, one side of the barrier 7 is provided with the first barrier slide guide 15. The other side is provided with the second barrier slide guide 16.

The first barrier slide guide 15 is constructed by engaging the first barrier engager 25 on the chassis 2 with the first rail-shaped barrier engaging unit 91 on the inside portion 81. The second barrier slide guide 16 is constructed by engaging the second barrier engager 26 on the chassis 2 with the second rail-shaped barrier engaging unit 92 on the inside portion 81.

The first barrier engaging unit 91 engages with the first barrier engager 25 through the first long hole 93 formed at one side of the inside portion 81. The first barrier engaging unit 91 gently presses the first to fourth rollers 11 to 14 against the principal plane 3 of the chassis 2. The second barrier engaging unit 92 engages with the second barrier engager 28 through the second long hole 94 formed at the other side of the inside portion 81. The second barrier engaging unit 92 gently presses the first to fourth rollers 11 to 14 against the principal plane 3 of the chassis 2. Along one sides of the first and second long holes 93 and 94, the barrier 7 moves to the first position to expose the imaging lens or to the second position to hide the imaging lens.

As shown in FIG. 14A, the first stoppers 18 are provided at one ends of the first and second rail-shaped barrier engaging units 91 and 92 along the longer direction. When the barrier 7 moves to the first position, the first stoppers 18 touch the first and second barrier engagers 25 and 26 to prevent the further movement. As shown in FIG. 14B, the second stoppers 19 are provided at the other ends of the first and second long holes 93 and 94. When the barrier 7 moves to the second position, the second stoppers 19 touch the first and second barrier engagers 25 and 26 to prevent the further movement. The first and second stoppers 18 and 19 of the second barrier engaging unit 92 are composed of the approximately horseshoe-shaped clips 98 that prevent the second and fourth rollers 12 and 14 from slipping out of the first to fourth roller receptacles 97.

(6) Construction of the Toggle Spring

When the barrier 7 is moved to the first position, the toggle spring 17 presses the first and second barrier engagers 25 and 26 against the first stopper 18 to keep the barrier opening. When the barrier 7 is moved to the second position, the toggle spring 17 presses the first and second barrier engagers 25 and 26 against the second stopper 19 to keep the barrier closing.

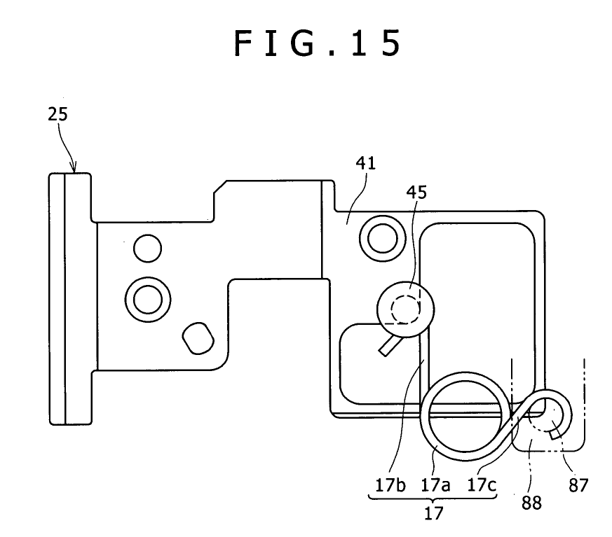

As shown in FIG. 15, the toggle spring 17 is a so-called twisted coil spring and is composed of a coil 17a, a first arm 17b, and a second arm 17c. The first arm 17b extends from one end of the coil 17a. The second arm 17c extends from the other end of the coil 17a.

The first arm 17b of the toggle spring 17 is rotatably fastened to the first spring locking portion 45 on the attaching base 41 of the first barrier engager 25. The second arm 17c of the toggle spring 17 is rotatably fastened to the second spring locking portion 87 on a cutout piece 88 of the metal plate 83 (see FIG. 12) attached to the inside portion 81.

As shown in FIG. 14A, when the barrier 7 is moved to the first position, the toggle spring 17 presses the first stopper 18 against the first and second barrier engagers 25 and 26 to keep the barrier opening. Moving the barrier 7 from the first position to the second position rotates (reverses) the coil 17a of the toggle spring 17. When the barrier 7 reaches a specified position, the toggle spring 17 applies a spring force in the reverse direction. As shown in FIG. 14B, the toggle spring 17 presses the second stopper 19 against the first and second barrier engagers 25 and 26 to keep the barrier 7 closing.

(7) Construction of the Memory Card Mounting Unit's Cover (Memory Card Cover)

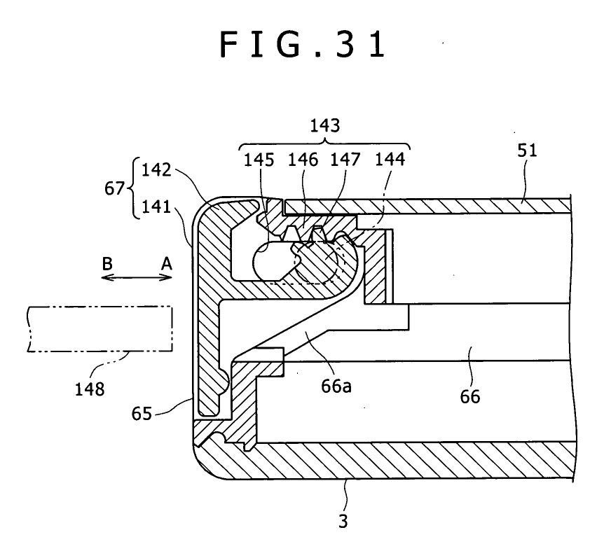

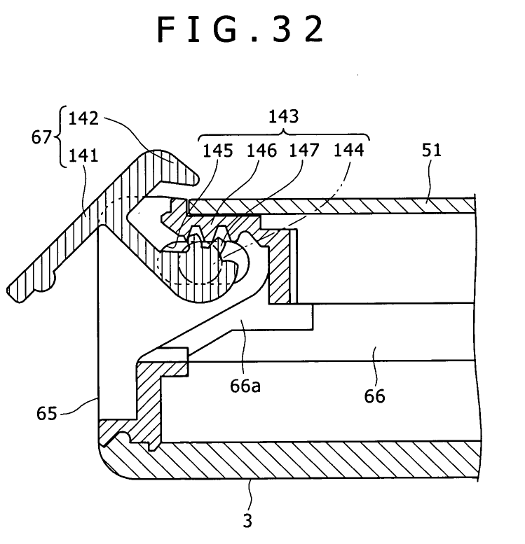

The memory card cover 67 opens or closes the opening of the memory card mounting unit 66. As shown in the sectional view of FIG. 31, the memory card cover 67 is composed of an end face aligning portion 141 (cover body) and a principal plane aligning portion 142. When the cover is closed, the end face aligning portion 141 approximately flat aligns to the second end face (bottom end face) 65 connecting the first principal plane 3 with the second principal plane 51. The principal plane aligning portion 142 approximately flat aligns to the second principal plane 51.

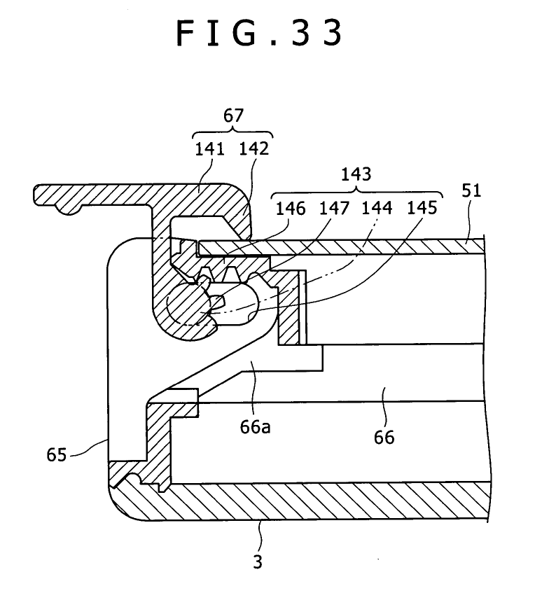

The cover rotating mechanism 143 is used to attach the memory card cover 67 to the chassis 2. The memory card cover 67 is rotatably attached to the chassis 2 between a first position (FIG. 31) to close the opening 66a of the memory card mounting unit 66 and a second position (FIG. 33) to open the opening 66a.

The cover rotating mechanism 143 is composed of a pivot 144 of the memory card cover 67, a long slot-shaped bearing 145, a rack 146, and a pinion 147. The long slot-shaped bearing 145 movably attaches the pivot 144 to the chassis 2. When the memory card cover 67 is opened or closed, the pivot 144 rotates. The rack 146 and the pinion 147 move the rotating pivot 144 along the long slot-shaped bearing 145.

The pivot 144 is provided to the memory card cover 67. The long slot-shaped bearing 145 is provided to the chassis 2. The pinion 147 is provided on the outside peripheral surface pivot 144. The rack 146 is provided along the direction of moving the pivot in the long slot-shaped bearing 145.

The long slot-shaped bearing 145 is provided approximately parallel to insertion direction A or ejection direction B of the memory card 148 to or from the memory card mounting unit 66. Closing the memory card cover 67 moves the pivot 144 inside the long slot-shaped bearing 145 in insertion direction A of the memory card 148. Opening the memory card cover 67 moves the pivot 144 inside the long slot-shaped bearing 145 in ejection direction B of the memory card 148.

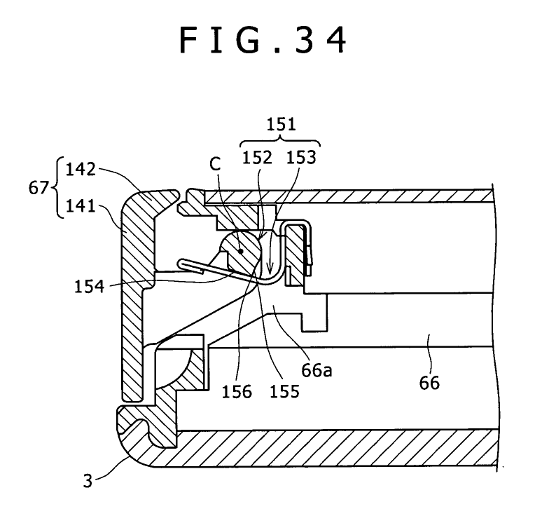

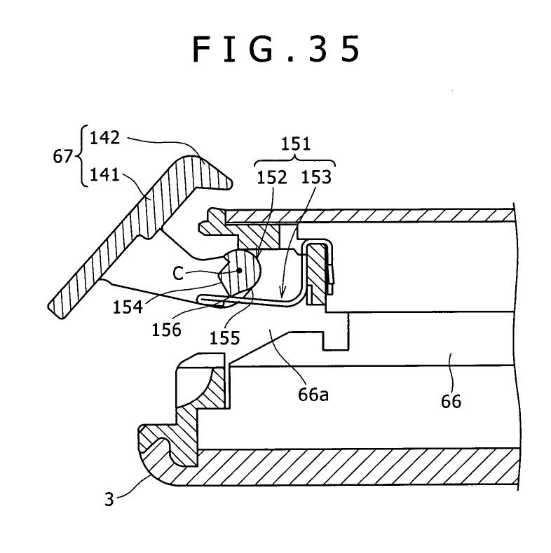

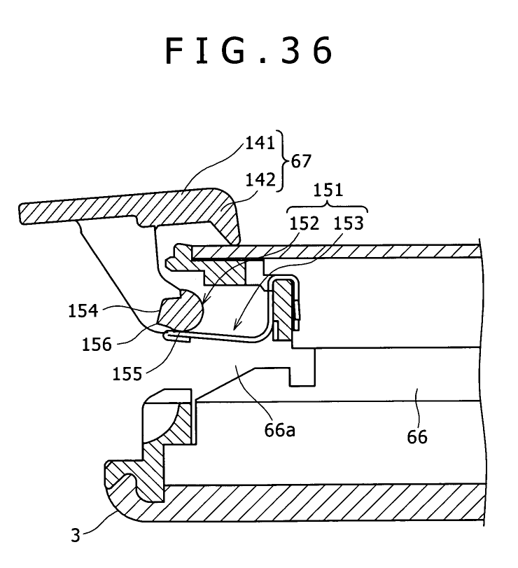

As shown in FIG. 34, a click mechanism 151 is provided. When the memory card cover 67 is closed, the click mechanism 151 presses the pivot 144 against the end of the long slot-shaped bearing 145 in insertion direction A (FIG. 31). When the memory card cover 67 is opened, the click mechanism 151 presses the pivot 144 against the other end of the long slot-shaped bearing 145 in ejection direction B (FIG. 33).

The click mechanism 151 is composed of a click shaft 152 and a spring (leaf spring) 153. The click shaft 152 is provided to the memory card cover 67 and rotates with the rotation of the memory card cover 67. The spring 153 is provided to the chassis 2 and contacts with the peripheral surface of the click shaft 152. The peripheral surface of the click shaft 152 is provided with first and second spring contact surfaces 154 and 155 continuously formed along the rotation direction of the click shaft 152. The first spring contact surface 154 allows the spring 153 to generate a force to press the pivot 144 toward the end of the long slot-shaped bearing 145 in insertion direction A of the memory card 148. The second spring contact surface 155 allows the spring 153 to generate a force to press the pivot 144 toward the end of the long slot-shaped bearing 145 in insertion direction B of the memory card 148.

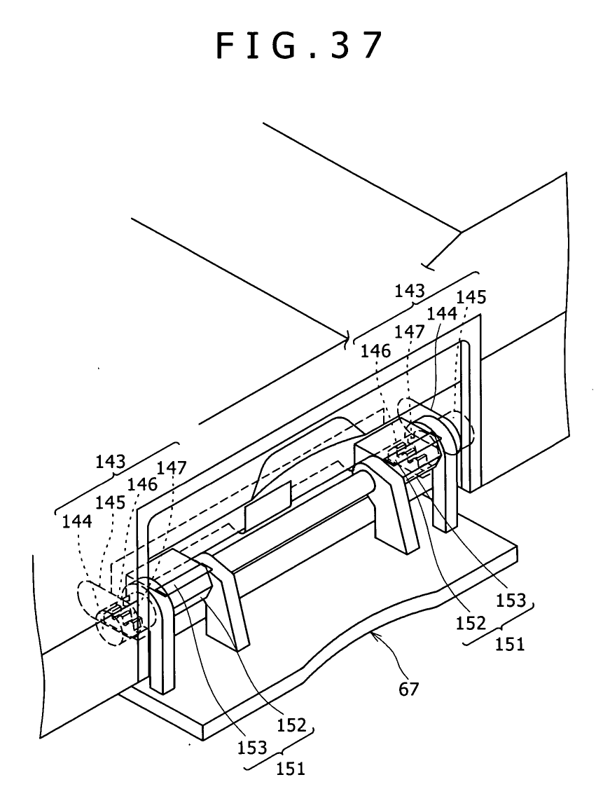

There is a boundary 156 between the first and second spring contact surfaces 154 and 155. The boundary 156 provides a neutral position that allows the spring 153 to generate no force to rotate the click shaft 152. A radial distance between center C of the click shaft 152 and the boundary 156 is larger than a radial distance between center C of the click shaft 152 and the first or second spring contact surface 154 or 155. FIG. 37 is a perspective view with the memory card cover 67 opened. A pair of the cover rotating mechanisms 143 is disposed at both sides of the memory card cover. A pair of click mechanisms 151 is disposed inside the cover rotating mechanisms 143.

In the above-mentioned construction, the memory card cover 67 according to the embodiment may be closed. In this state, the outside surface of the memory card cover 67 is approximately level with the outside surface of the chassis 2 as shown in FIG. 31. Opening the memory card cover 67 gradually protrudes it from the chassis 2. When fully opened as shown in FIG. 33, the memory card cover 67 protrudes from the second principal plane 51 of the chassis 2 for the height of the principal plane aligning portion 142. The end face aligning portion (cover body) 141 becomes parallel to the second principal plane 51.

(8) Construction of the Battery Mounting Unit's Cover (Battery Cover)

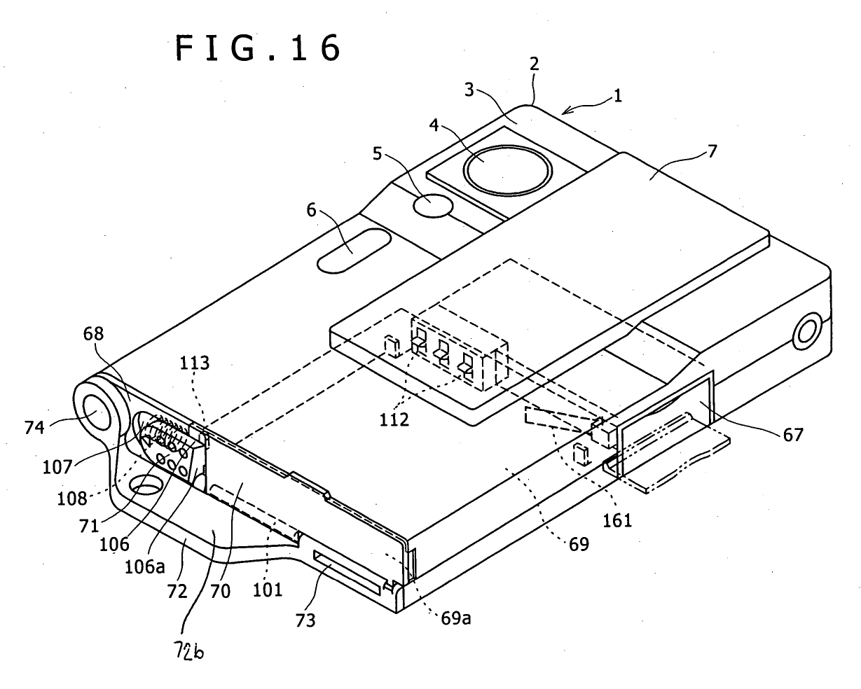

As shown in FIG. 16, the end face 68 connects the first principal plane 3 with the second principal plane 51. The end face 68 is provided with the battery cover 70, the battery release lever 71, the strap fitting 72, and the multi-connector connection terminal 73. The battery cover opens and closes the opening 69a of the battery mounting unit 69. The battery release lever 71 allows a battery to be inserted to or removed from the battery mounting unit 69. The strap fitting 72 overlaps with the battery cover 70 when opened. The battery release lever 71 is disposed adjacently to the outside of one end of the battery cover in the longer direction.

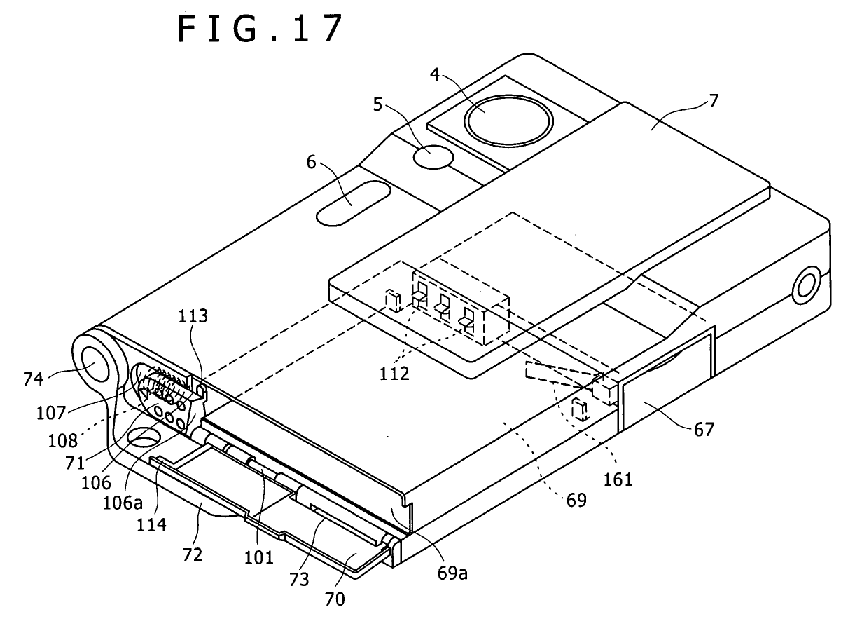

The battery cover 70 is rotatably attached to the chassis 2 by means of a shaft 101. When rotated clockwise around the shaft 101 as shown in FIG. 16, the battery cover 70 overlaps with the end face 68 to close the opening 69a. In the state in FIG. 16, the battery cover 70 can be rotated approximately 100° counterclockwise to open as shown in FIG. 17. The battery cover 70 overlaps with the strap fitting 72 that prevents the battery cover 70 from further rotating for protection.

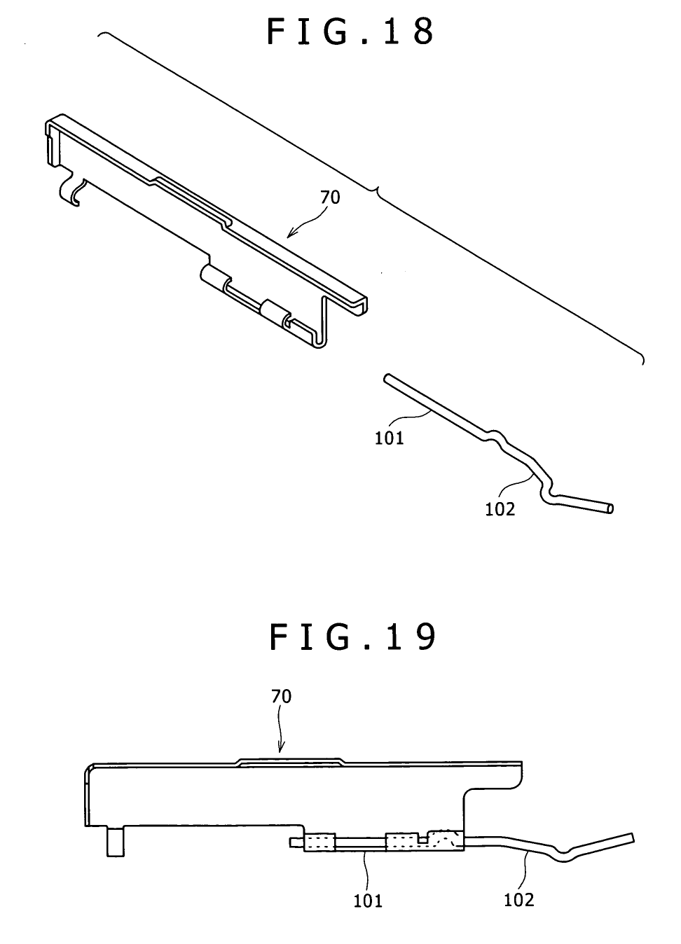

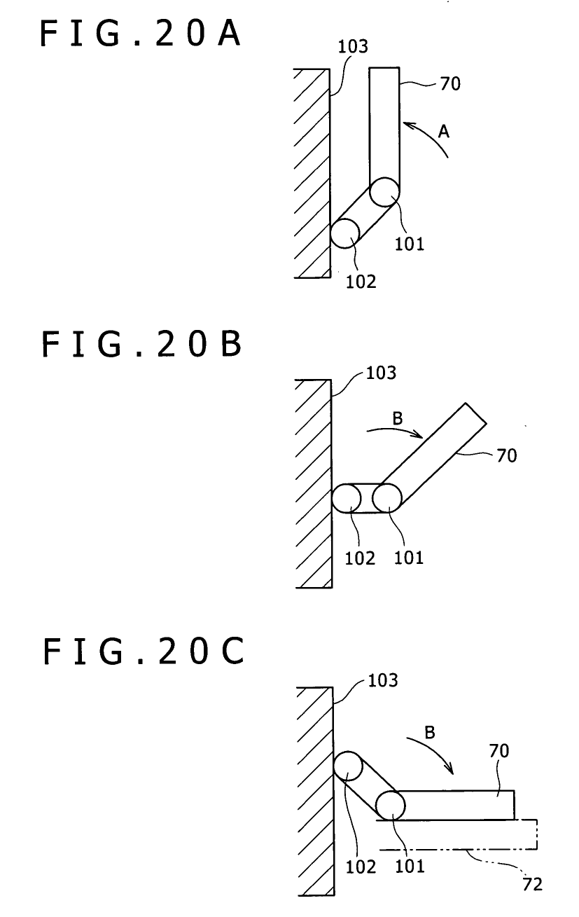

As shown in FIG. 18, the shaft 101 is made of an elastic metal rod. One end of the shaft 101 is provided with a spring portion 102. When the battery cover 70 is closed, the spring portion 102 presses the battery cover 70 against the end face 68 of the chassis 2. When the battery cover 70 is opened, the spring portion 102 presses the battery cover 70 against the strap fitting 72. The spring portion 102 is formed integrally with the shaft 101 by bending one end of the shaft 101. As shown in FIGS. 20A, 20B, and 20C, the spring portion 102 touches a spring contact surface 103 provided for the chassis 2.

When the battery cover 70 is closed as shown in FIG. 20A, the spring portion 102 touches the spring contact surface 103 provided for the chassis 2. The spring portion 102 supplies the shaft 101 and the battery cover 70 with a rotating force in the direction of arrow A (clockwise). The spring portion 102 presses the battery cover 70 against the end face 68 of the chassis 2. When the battery cover 70 is rotated in the opening direction (indicated by arrow B) from the state as shown in FIG. 20A, the spring portion 102 is pressed against the spring contact surface 103 and is deformed. The spring portion 102 is most deformed when the battery cover 70 is opened at a specified angle, e.g., 45°, as shown in FIG. 20B. At this time, the spring portion 102 reaches the neutral position where no rotating force is applied to the shaft 101 and the battery cover 70. When the battery cover 70 is further rotated in the opening direction (indicated by arrow B) from the state as shown in FIG. 20B, the spring portion 102 generates a spring force in the direction (indicated by arrow B) to open the battery cover 70. As shown in FIG. 20C, the battery cover 70 is pressed against the strap fitting 72 to leave the opening 69a of the chassis 2 opened.

(9) Construction of the Battery Release Lever

As shown in FIGS. 16 and 17, the battery release lever 71 is attached to a lever guide 107 provided for the first end face 68. One end of the battery release lever 71 is provided with a battery engaging portion 106 that can slide between a position to partially close the opening 69a of the battery mounting unit 69 and a position to open the opening 69a. The spring 108 is disposed at the bottom of the battery release lever 71. The spring 108 presses the battery release lever 71 to a position that partly closes the opening 69a of the battery mounting unit 69. A slant battery pushing surface 106a is formed on the battery engaging portion 106.

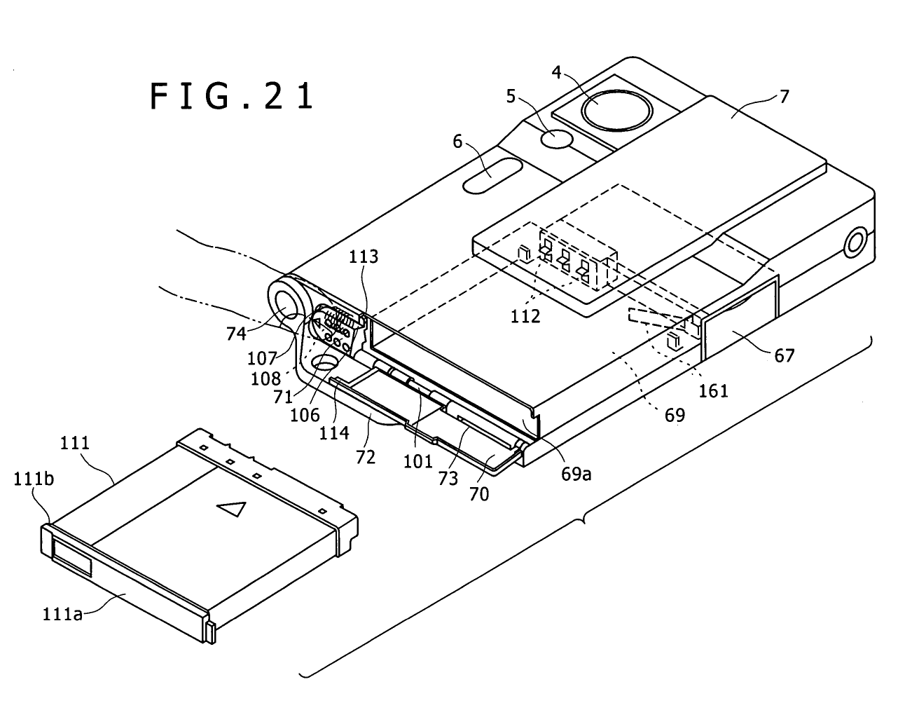

As shown in FIG. 21, the battery release lever 71 is slid back against the force of the spring 108 to a position to open the opening 69a, i.e., a position capable of inserting the battery 111. The battery 111 is then inserted into the battery mounting unit 69. When the battery 111 is inserted into the battery mounting unit 69, the tip end face of the battery 111 presses the battery ejection spring 161 to accumulate a force. A terminal at the tip end face of the battery 111 contacts with a battery terminal at the inside end of the battery mounting unit 69.

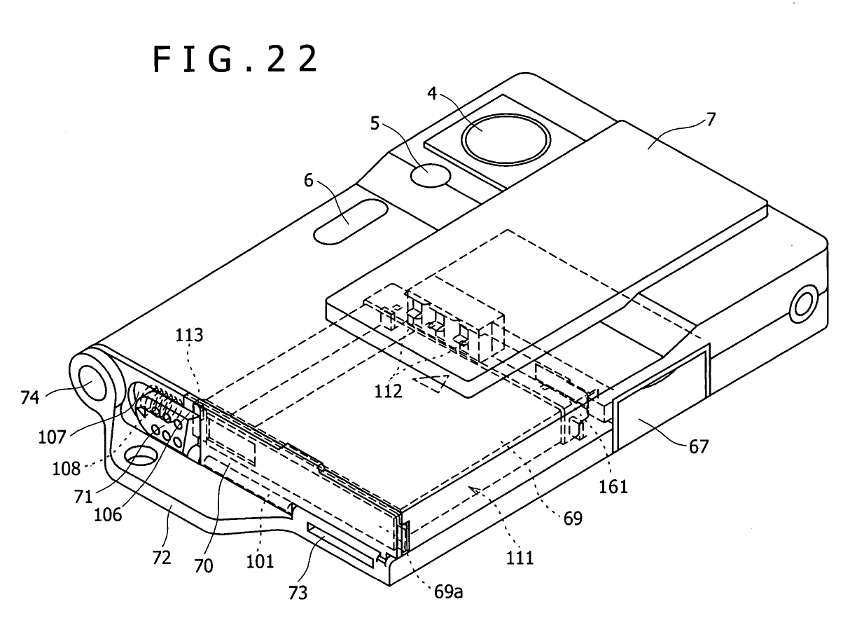

After the battery 111 is placed in the battery mounting unit 69, the battery release lever 71 may be freed from being slid back. Due to a spring force of the spring 108, the battery release lever 71 automatically returns to a position to partially close the opening 69a of the battery mounting unit 69. In this manner, the battery release lever 71 prevents the battery 111 from being removed from the battery mounting unit 69. As shown in FIG. 22, closing the battery cover 70 completes the operation of inserting the battery 111.

When the battery cover 70 is kept closed, there may be a possibility of sliding back the battery release lever 71. When the battery release lever is inadvertently slid back, the battery 111 may be pushed out of the battery mounting unit 69 due to a spring force of the battery contact terminal 112 at the inside end of the battery mounting unit and due to a spring force of the battery ejection spring. When the battery 111 is slightly pushed out, the presence of the battery cover 70 may make it unclear that the battery 111 is incompletely mounted in the battery mounting unit 69.

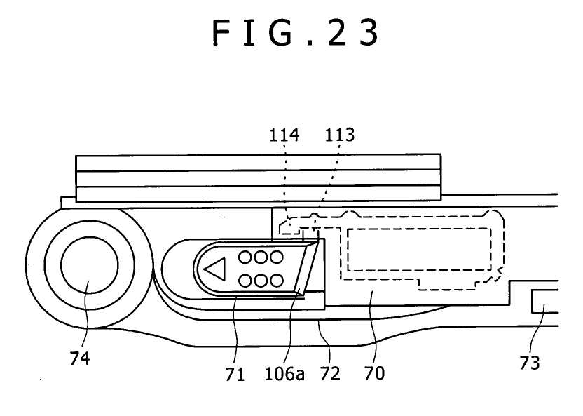

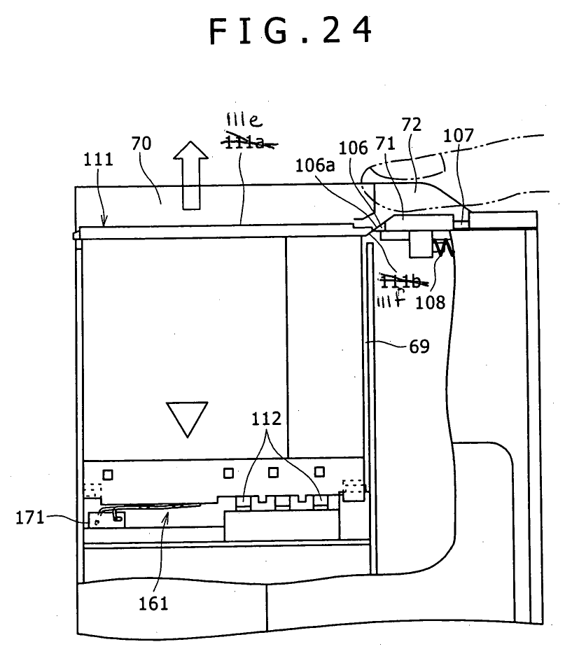

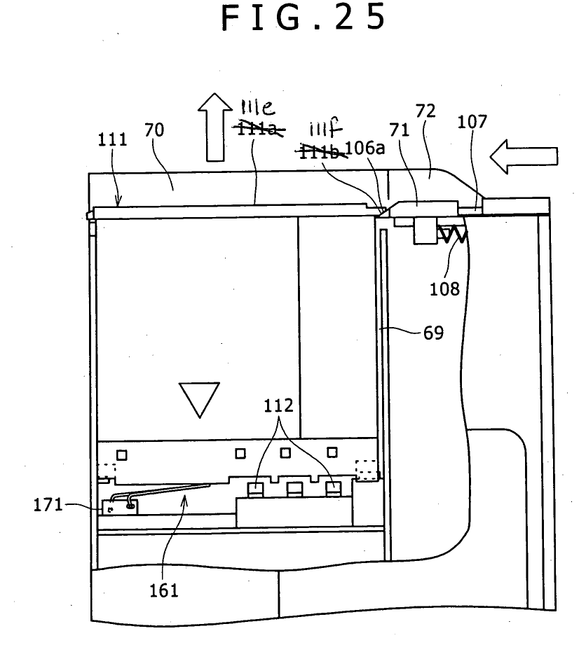

To solve this problem, as shown in FIG. 21, the battery release lever 71 is provided with a cover engaging portion 113. On the other hand, the battery cover 70 is provided with a battery release lever engaging portion 114. As shown in FIG. 23, closing the battery cover 70 positions the battery release lever engaging portion 114 to the side of the cover engaging portion 113. When an attempt is made to slide back the battery release lever 71, the cover engaging portion 113 engages with the battery release lever engaging portion 114. The battery cover 70 is kept closed to prevent the battery release lever 71 from being slid back.

The battery 111 can be removed from the battery mounting unit 69 by opening the battery cover 70 and then sliding back the battery release lever 71 against the force applied from the spring 108. Sliding back the battery release lever 71 releases the battery ill from being seated. As shown in FIG. 24, the battery 111 is pushed out of the battery mounting unit 69 due to a spring force of the battery contact terminal 112.

After the battery 111 is pushed out due to the spring force of the battery contact terminal 112, the battery release lever 71 may be moved to the battery 111. As shown in FIG. 25, a battery pushing surface 106a is provided on the battery engaging portion 106 of the battery release lever 71. A slope 111b is provided on a plate 11a of the battery 111. Moving the battery release lever 71 to the battery 111 allows the battery pushing surface 106a to press the slope 111b and further push the battery 111 out of the battery mounting unit 69.

(10) Construction of the Strap Fitting

The strap fitting 72 is used to attach a wrist strap, a neck strap, and the like for safety. In addition, a user may feel it easy to hold the chassis 2 when he or she places his or her thumb or the like on the strap fitting 72.

As shown in FIGS. 2 and 16, the strap fitting 72 is formed integrally with the chassis 2 so as to be raised from the end face 61 along the side edge of the second principal plane 51 of the chassis 2. The strap fitting 72 has a first surface 72a on the second principal plane 51 and a second surface 72b opposite the first surface 72a. The second surface 72b contacts with the battery cover 70. The second surface 72b is formed so as to allow for tilt angle θ at least greater than 90° against the end face 61 of the chassis 2 or the opening 69a of the battery mounting unit 69. The first surface 72a is provided with a groove-shaped engaged portion 115 that engages with an engaging portion 127 of a multi-connector 121 (to be described). When the multi-connector 121 is connected to the multi-connector connection terminal 73, the engaged portion 115 prevents the multi-connector 121 from being removed from the multi-connector connection terminal 73. In addition, the strap fitting 72 is provided with a hole 116 to attach a strap.

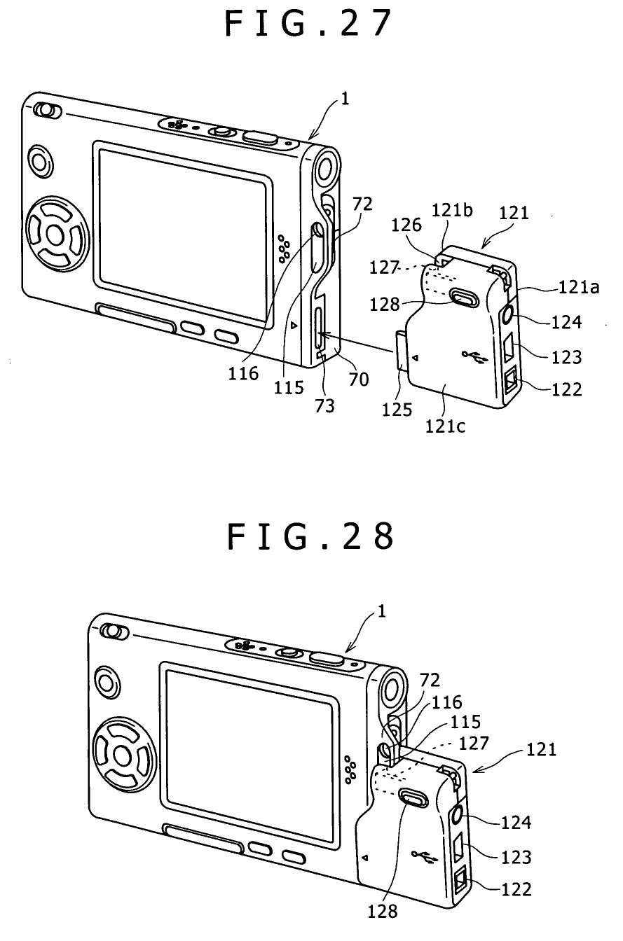

FIG. 27 shows the multi-connector 121 connected to the multi-connector connection terminal 73. The multi-connector 121 has a first side surface 121a that is provided with a DC input terminal 122, a USV terminal 123, and an A/V output terminal 124. The multi-connector 121 has a second side surface 121b that is provided with a terminal 125 and a strap fitting insertion recess 126. The terminal 125 is inserted into the multi-connector connection terminal 73. The strap fitting insertion recess 126 is used to engage with the strap fitting 72. The inside of the strap fitting insertion recess 126 is provided with a engaging portion 127 that engages with the groove-shaped engaged portion 115 of the strap fitting 72. The multi-connector 121 has a third side surface 121c that is provided with a disengaging button 128 that is used to disengage the engaging portion 127 from the engaged portion 115.

As shown in FIG. 27, the terminal 125 can be inserted into the multi-connector connection terminal 73 approximately straight from the side of the camera 1. As shown in FIG. 28, the strap fitting 72 is accordingly inserted into the strap fitting insertion recess 126. Further, the engaging portion 127 engages with the engaged portion 115 to lock the multi-connector 121 to the camera 1.

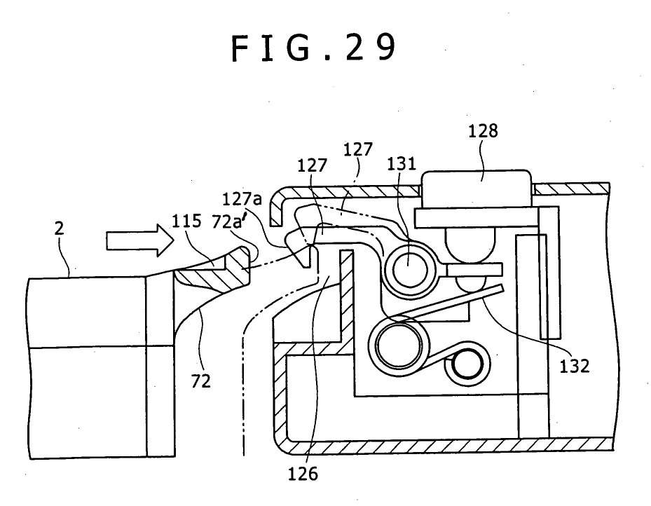

FIG. 29 is a partially sectional view of the multi-connector 121. The nail-shaped engaging portion 127 is rotatable around a shaft 131 and protrudes into the strap fitting insertion recess 126 by means of a spring 132. When the strap fitting 72 is inserted into the strap fitting insertion recess 126, a tip end face 72a of the strap fitting 72 presses a tip slope 127a of the engaging portion 127. The engaging portion 127 rotates in a retracting direction against a force applied from the spring 132. When the strap fitting 72 is completely inserted into the strap fitting insertion recess 126, there is no pressure between the tip end face 72a of the strap fitting 72 and the tip slope 127a of the engaging portion 127. The engaging portion 127 automatically rotates by means of a force of the spring 129 to engage with the groove-shaped engaged portion 115.

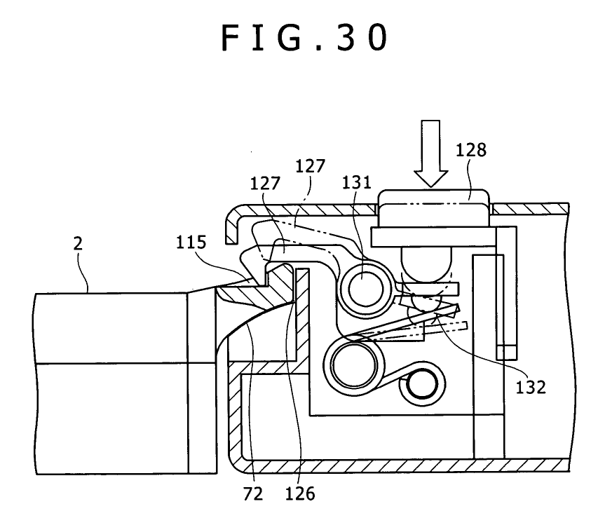

Pressing the disengaging button 128 removes the multi-connector 121 from the camera 1. As shown in FIG. 30, the engaging portion 127 rotates in the retracting direction against the force applied from the spring 129. The engaging portion 127 is disengaged from the groove-shaped engaged portion 115 to be detachable from the camera 1.

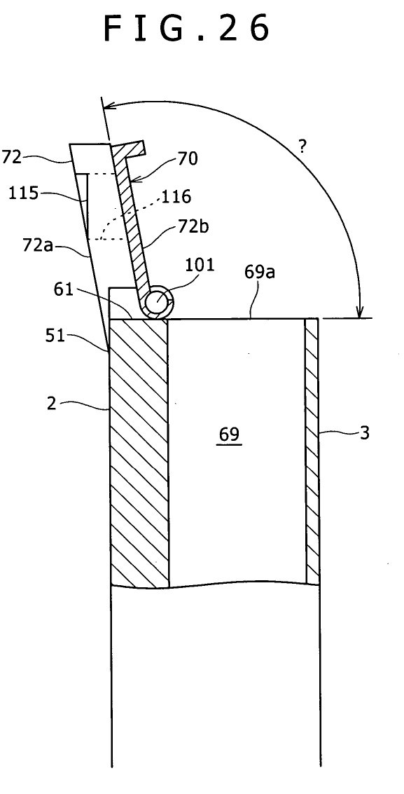

As mentioned above, the multi-connector 121 is constructed to engage with the strap fitting 72. This structure provides the following effect compared to a structure that does not allow the multi-connector to engage with the strap fitting. For example, a cord connected to the multi-connector 121 may be pulled to apply a large force. In such case, the force is not directly applied to a connector connecting portion, making it possible to protect the connector or the terminal. FIGS. 1 and 2, for example, represent the cubic diagrams of the imaging apparatus. FIGS. 12 through 26, for example, represent the plane views of the imaging apparatus. The curved surfaces, cylindrical surfaces, and the like may contain slight differences in the curvature radiuses, the tilt angles, and the like. Such differences, if any, should be considered to be drawing errors. The same reference numeral represents the same portion. The imaging apparatus' cubic diagrams in FIGS. 1 and 2, for example, may seemingly differ from those in FIGS. 16 and 17, for example. The curved surfaces, cylindrical surfaces, and the like may contain slight differences in the curvature radiuses, the tilt angles, and the like. Such differences, if any, should be also considered to be drawing errors. The cross-hatching is partly omitted from the sectional views.

(11) Other Embodiments

According to the above-mentioned embodiment, the memory card mounting unit 66 is provided at the center of the camera body 2. The memory card 148 is mounted or dismounted from the opening 66a in the bottom end face 65 of the camera body 2. The battery mounting unit 69 is provided orthogonally to the memory card mounting unit 66. The battery 111 is mounted or dismounted from the opening 69a in the side end face 68 of the camera body 2. According to another construction, the battery mounting unit may be provided at the center of the camera body 2. The battery 111 may be mounted or dismounted from the opening 69a in the bottom end face 65 of the camera body 2. The memory card mounting unit 66 may be provided orthogonally to the battery mounting unit 69. The memory card 148 may be mounted or dismounted from the opening 66a in the side end face 68 of the camera body 2. In the above-mentioned embodiment, the digital camera has been described as an example of electronic devices. The present invention can be broadly applied to small electronic devices that use memory cards and batteries. For example, such electronic devices include not only imaging apparatuses such as the digital camera, but also cellular phones and handheld gaming machines.

It should be understood by those skilled in the art that various modifications, combinations, sub-combinations and alterations may occur depending on design requirements and other factors insofar as they are within the scope of the appended claims or the equivalents thereof.

1. An electronic device, comprising
a flat chassis;
a recording medium mounting unit on the chassis; and
a battery mounting unit on the chassis;
one of the recording medium mounting unit and the battery mounting unit being positioned approximately at the center of the chassis and another of the recording medium mounting unit and the battery mounting unit being positioned to one side of the one mounting unit; and
an opening of the one mounting unit being provided on a first end face of the chassis and an opening of the another mounting unit being provided on a second end face of the chassis continuous with the first end face of the chassis.

2. The electronic device according to claim 1,
wherein the one mounting unit is the recording medium mounting unit and the another mounting unit positioned to the one side of the one mounting unit is the battery mounting unit.

3. The electronic device according to claim 2, further comprising:
a main circuit board arranged on the chassis so as to overlap with the recording medium mounting unit.

4. The electronic device according to claim 3, further comprising:
a battery contact terminal provided at one side of the main circuit board and between the recording medium mounting unit and the battery mounting unit, the battery contact terminal being adapted to contact a terminal of a battery mounted in the battery mounting unit.

5. The electronic device according to claim 1, further comprising:
a divider plate operable to divide an inside of the chassis into a first parts mounting space positioned between the divider plate and a first principal plane of the chassis, a second parts mounting space positioned between the divider plate and a second principal plane of the chassis, and a third parts mounting space free from the divider plate.

6. The electronic device according to claim 5, wherein the recording medium mounting unit and the battery mounting unit are positioned in the first parts mounting space, the electronic device further comprising:
a main circuit board, a capacitor, an AF illuminator, and a flash unit positioned in the first parts mounting space.

7. The electronic device according to claim 6, wherein
the capacitor is arranged between the battery mounting unit and a third end face of the chassis opposite the first end face of the chassis; and
the AF illuminator and the flash unit are arranged between the recording medium mounting unit and the third end face of the chassis.

8. The electronic device according to claim 5, further comprising:
a liquid crystal panel arranged in the second parts mounting space.

9. The electronic device according to claim 5, further comprising:
a lens unit arranged in the third parts mounting space.

10. The electronic device according to claim 9, wherein the lens unit includes an imaging lens arranged at the fourth end face of the chassis.

11. The electronic device according to claim 10, further comprising:
an iris driving unit provided on one side of the lens unit arranged in the third parts mounting space, at least part of the iris driving unit projecting into the first parts mounting space.

12. The electronic device according to claim 11, further comprising:
a main circuit board positioned in the first parts mounting space, the main circuit board and the recording medium mounting unit being provided with a cutout to accommodate the at least part of the iris driving unit projecting into the first parts mounting space.

13. The electronic device according to claim 11, further comprising:
a liquid crystal panel arranged in the second parts mounting space, wherein
the iris driving unit is displaced so as to project toward the first principal plane of the chassis from the lens unit, and
a bottom of the iris driving unit includes a panel support hole for receiving one end of the liquid crystal panel.

14. The electronic device according to claim 13, wherein the first principal plane of the chassis includes a protrusion guide hole for receiving a portion of the iris driving unit protruding toward the first principal plane of the chassis.

15. The electronic device according to claim 5, wherein one end of the divider plate is positioned toward the second end face of the chassis and another end of the divider plate is positioned toward the fourth end face of the chassis through a pair of arms.

16. The electronic device according to claim 1, further comprising:
a strap fitting provided on an outside of the second end face of the chassis.

17. The electronic device according to claim 16, wherein the second end face of the chassis and the strap fitting are integrally formed by means of aluminum die casting.
